(19) United States
(12) Patent Application Publication
(10) Pub. No.: US 2024/0281790 A1
(43) Pub. Date: Aug. 22, 2024

(54) POINT-OF-SALE APPARATUS AND COMMODITY INFORMATION REGISTRATION SYSTEM

(71) Applicant: Toshiba Tec Kabushiki Kaisha, Tokyo (JP)

(72) Inventor: Hidehiro NAITO, Mishima Shizuoka (JP)

(21) Appl. No.: 18/409,088

(22) Filed: Jan. 10, 2024

(30) Foreign Application Priority Data
Feb. 21, 2023 (JP) 2023-025113

(51) Int. Cl. G06Q 20/20

(52) U.S. Cl. CPC G06Q 20/208

(57) ABSTRACT

According to one embodiment, a point-of-sale apparatus includes a connection interface connectable to a point-of-sale (POS) terminal and a control unit connectable to an imaging unit. The control unit is configured to acquire a captured image of a commodity from the imaging unit, attempt to identify the commodity in the image using a code symbol attached to the commodity, attempt to identify the commodity based on external appearance feature data of the commodity in in the captured image, and output commodity identification information for the commodity to the POS terminal according to either the code symbol or the external feature data.

### CROSS-REFERENCE TO RELATED APPLICATION

This application is based upon and claims the benefit of priority from Japanese Patent Application No. 2023-025113, filed Feb. 21, 2023, the entire contents of which are incorporated herein by reference.

### FIELD

Embodiments described herein relate generally to a point-of-sale apparatus and a commodity information registration system.

### BACKGROUND

In stores where commodities or services (hereinafter collectively referred to as “commodities”) are sold, point of sales (POS) systems are used. Some types of POS systems include scanners that read commodity codes from barcodes (“commodity barcodes”) attached to the commodities. POS systems register information regarding the commodities to be purchased based on the commodity codes read by scanners.

Since operators operating the POS systems are required to find the commodity barcodes on the commodities and hold the commodity barcodes up to the scanners, the operations for reading the commodity barcodes can be slow and burdensome. That is, it takes time and effort for the operators to perform the “commodity registration” operations. In particular, in what are called “self-service POS systems,” customers inexperienced with the commodity registration operations may be required to scan the commodity barcodes themselves. Therefore, it is desirable to improve operability of POS systems for performing commodity code reading. In other words, to reduce the burden on an operator's performance in registering the commodities for purchase.

### BRIEF DESCRIPTION OF THE DRAWINGS

FIG. 1 depicts an external appearance of a self-service POS system according to an embodiment.

FIG. 2 is a block diagram of a self-service POS system according to an embodiment.

FIG. 3 is a diagram illustrating a data configuration of a commodity master stored in a storage unit of a POS terminal.

FIG. 4 is a block diagram depicting aspects related to a control unit of a POS terminal according to an embodiment.

FIG. 5 is a diagram illustrating a data configuration of a code information management table stored in a storage unit of a scanner.

FIG. 6 is a block diagram depicting aspects related to a control unit of a scanner according to an embodiment.

FIGS. 7A and 7B are diagrams illustrating an output timing of a commodity code by a control unit of a scanner according to an embodiment.

FIG. 8 is a flowchart of a first specifying process of a control unit of a scanner according to an embodiment.

FIG. 9 is a flowchart of a second specifying process by a control unit of a scanner according to an embodiment.

### DETAILED DESCRIPTION

An exemplary embodiment provides an point-of-sale apparatus and a commodity information registration system capable of improving operability of such apparatuses and systems.

In general, according to one embodiment, a point-of-sale apparatus includes a connection interface connectable to a point-of-sale (POS) terminal and a control unit connectable to an imaging unit. The control unit is configured to acquire a captured image of a commodity from the imaging unit, attempt to identify the commodity in the image using a code symbol attached to the commodity, attempt to identify the commodity based on external appearance feature data of the commodity in in the captured image, and output commodity identification information for the commodity to the POS terminal according to either the code symbol or the external feature data.

Hereinafter, certain apparatuses and the systems according to example embodiments will be described with reference to the drawings. Embodiments are not limited to these specific examples. For example, a scanner will be described as an example of an information processing apparatus, but the disclosure is not limited thereto. The information processing apparatus may be a POS terminal.

In some examples, the information processing apparatus may be a scanner and a POS terminal in combination or an integrated whole. In such a case, functions described for a scanner may be implemented by a POS terminal and/or a scanner combined with the POS terminal. In some examples, just the decoding of a commodity barcode may be performed by the POS terminal.

In an embodiment, a self-service POS system will be used as an example of a commodity information registration system, but the disclosure is not limited thereto. The commodity information registration system may be a POS system operated by a store clerk or the like.

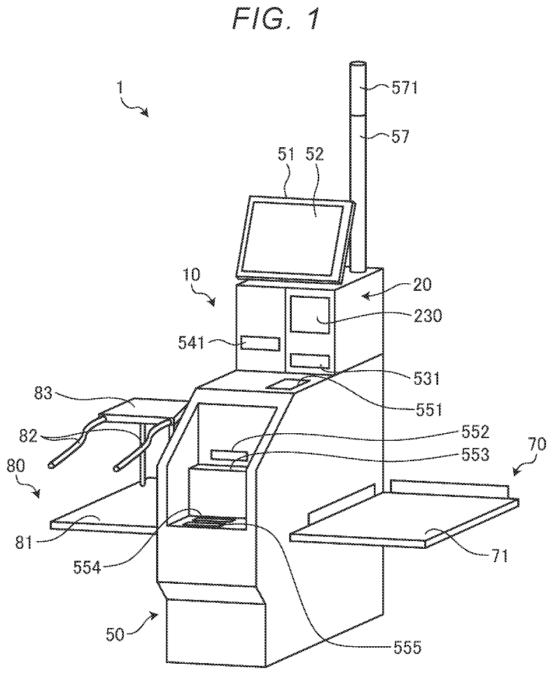

FIG. 1 is a perspective view illustrating the external appearance of a self-service POS system 1. The self-service POS system 1 includes a POS terminal 10 and a scanner 20 built in the POS terminal 10. Here, the self-service POS system 1 is an example of a commodity information registration system, the POS terminal 10 is an example of a registration apparatus, and the scanner 20 is an example of an information processing apparatus.

The scanner 20 identifies a commodity to be purchased by a customer and outputs the commodity code of the identified commodity to the POS terminal 10. The commodity code is an example of commodity identification information. The POS terminal 10 performs commodity registration based on the commodity code from the scanner 20 and performs a payment process for paying for the registered commodity. The payment process is a process performed by the POS terminal 10 in order for the customer to pay the purchase price of the registered commodities.

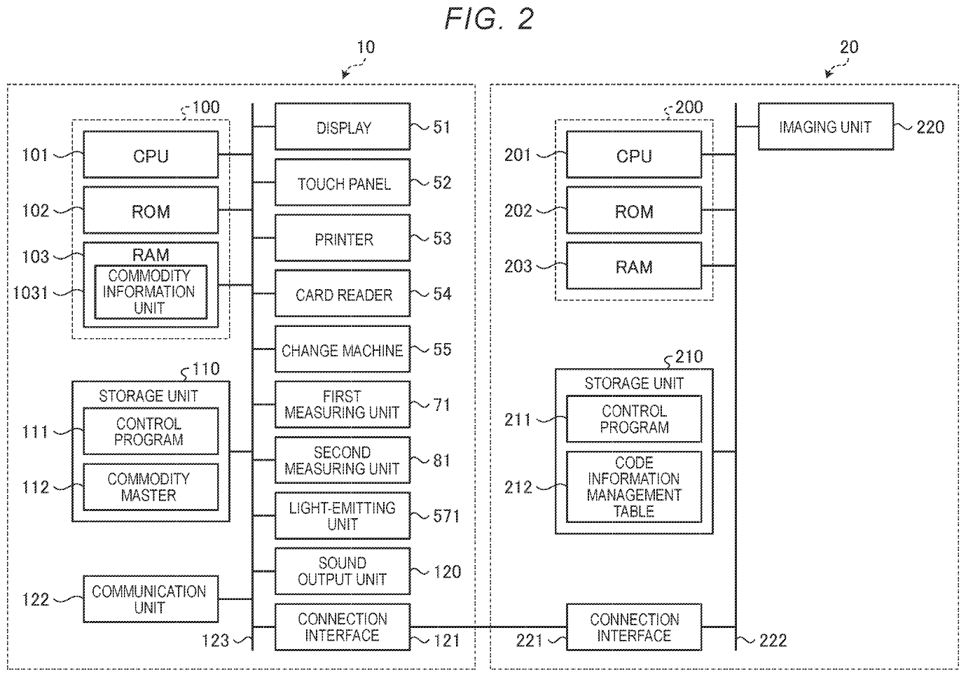

As illustrated in FIG. 1, the POS terminal 10 includes a main body 50, a first basket placement table 70, and a second basket placement table 80. The main body 50 includes a display 51 and a touch panel 52 in the upper part and accommodates a printer 53, a card reader 54, and a change machine 55 (see FIG. 2).

The display 51 is a display device such as a liquid crystal display (LCD) and displays various kinds of information. For example, the display 51 displays commodity information such as a commodity name or a price of the commodity subjected to the commodity registration. The display 51 displays payment information such as a sum amount due or a change amount due for a transaction while the customer can perform a payment operation.

The touch panel 52 is provided on the surface of the display 51 and receives information by the touched position and sends such information to a control unit 100 (see FIG. 2) of the POS terminal 10. The customer using the POS terminal 10 can operate the touch panel 52 by touching various buttons or operation keys displayed on the display 51.

As illustrated in FIG. 1, a reading window 230 of the scanner 20, a dispense port 531 of a receipt printed by the printer 53, and a card insertion port 541 of the card reader 54 are formed below the display 51 to face the customer.

The reading window 230 is a window used for the scanner 20 to image the commodity. A customer operating the self-service POS system 1 performs an operation for commodity registration by holding the commodity to be purchased to the reading window 230. The customer may hold the commodity to the reading window 230 while changing the facing direction of the commodity relative to the reading window 230 until the self-service POS system 1 performs the commodity registration and generates a registration completion sound.

The scanner 20 identifies the commodity by using a captured image of the commodity. Specifically, in the embodiment, the scanner 20 performs both a first specifying method based on any commodity barcode included in the captured image and a second specifying method based on the external appearance features of the commodity as depicted in the captured image. The commodity barcode is an example of a code symbol that may be attached to commodities.

The dispense port 531 is an opening through which the receipt printed by the printer 53 is discharged. On the receipt, information related to a transaction subjected to the payment process by the POS terminal 10 is printed. In some examples, POS terminal 10 may be set to issue an electronic receipt instead of dispensing a paper receipt printed by the printer 53.

The card insertion port 541 is an opening into which a credit card or the like can be inserted into card reader 54. For example, if the customer makes a payment with a credit card or if the customer provides a membership card or the like of a store to be read, the card is inserted via the card insertion port 541.

In the main body 50, a coin insertion port 551, a coin discharge port 552, a coin tray 553, a bill insertion port 554, and a bill discharge port 555 are formed corresponding to the position of the change machine 55 accommodated inside.

The coin insertion port 551 is an opening into which coins paid by the customer are inserted. The coins inserted into the coin insertion port 551 are subsequently stored in the change machine 55. The coin discharge port 552 is an opening through which coins dispensed from the change machine 55 are discharged. The coin discharge port 552 discharges money or coins inserted from the coin insertion port 551 but not accepted by the change machine 55. The coin tray 553 receives coins discharged from the coin discharge port 552. The bill insertion port 554 is an opening into which bills paid by the customer are inserted. The bills inserted into the bill insertion port 554 are accommodated in the change machine 55. The bill discharge port 555 is an opening through which bills are discharged as a change from the change machine 55.

The first basket placement table 70 is a stand on which a shopping basket or the like for holding the commodities to be purchased by the customer can be placed. The first basket placement table 70 includes a first measuring unit 71. The first measuring unit 71 measures a total weight of the shopping basket placed on the first basket placement table 70 and the commodities held in the shopping basket.

The second basket placement table 80 is a stand on which a shopping basket or the like for holding commodities for which commodity codes have been read by the scanner 20 (that is, commodities that have been subjected to commodity registration) can be placed. The second basket placement table 80 includes a second measuring unit 81, a pair of support rods 82, and a temporary stand 83.

The second measuring unit 81 measures a total weight of items placed on the second basket placement table 80 and/or a total weight of items held in a shopping bag or the like supported by the pair of support rods 82. The support rod 82 is a rod for hooking and supporting a shopping bag or the like. The support rod 82 supports the shopping bag in an open state so that it is easy to place the commodities into the shopping bag. The temporary stand 83 is a table on which commodities that are easily broken or deformed, such as a soybean curd or an egg, may be temporarily placed after being subjected to commodity registration. The customer can ultimately place the commodities that were placed on the temporary stand 83 into the shopping basket or the shopping bag.

The customer holds the commodities taken out from the shopping basket placed on the first basket placement table 70 to the reading window 230 to perform the commodity registration. Then, the customer places the commodities subjected to the commodity registration into the shopping basket placed on the second basket placement table 80 or into the shopping bag supported by the support rod 82.

The first measuring unit 71 measures weights before and after the commodities are taken out from the shopping basket placed on the first basket placement table 70, and then the control unit 100 (see FIG. 2) recognizes a change in the weight. The second measuring unit 81 measures weights before and after the commodities are placed into the shopping basket placed on the second basket placement table 80 or into the shopping bag supported by the support rod 82, and then the control unit 100 recognizes a change in the weight. The control unit 100 can determine whether the commodities to be purchased by the customer have all been subjected to the commodity registration based on whether the weight changes equal.

The main body 50 includes a columnar pole 57 extending upward. A light-emitting unit 571 that emits light if the customer calls a store clerk is provided at the upper tip end of the pole 57.

FIG. 2 is a block diagram illustrating a hardware configuration of the self-service POS system 1. The self-service POS system 1 includes the POS terminal 10 and the scanner 20. The POS terminal 10 and the scanner 20 are communicably connected to each other via connection interfaces 121 and 221.

First, a hardware configuration of the POS terminal 10 will be described.

The POS terminal 10 includes a control unit 100, a storage unit 110, a display 51, a touch panel 52, a printer 53, a card reader 54, a change machine 55, a first measuring unit 71, a second measuring unit 81, a light-emitting unit 571, a sound output unit 120, a connection interface 121, and a communication unit 122. The control unit 100, the storage unit 110, the display 51, the touch panel 52, the printer 53, the card reader 54, the change machine 55, the first measuring unit 71, the second measuring unit 81, the light-emitting unit 571, the sound output unit 120, the connection interface 121, and the communication unit 122 are connected to each other via a bus 123 or the like.

The control unit 100 includes a central processing unit (CPU) 101, a read only memory (ROM) 102, and a random access memory (RAM) 103. The CPU 101, the ROM 102, and the RAM 103 are connected to each other via the bus 123.

The CPU 101 controls the entire POS terminal 10. The ROM 102 stores various types of data or various programs such as a program used to drive the CPU 101. The RAM 103 is used as a work area of the CPU 101, and various programs or various types of data stored in the ROM 102 or the storage unit 110 are loaded. The control unit 100 performs various control processes of the POS terminal 10 when the CPU 101 operates according to a control program stored in the ROM 102 or the storage unit 110 and then loaded on the RAM 103.

The RAM 103 includes a commodity information unit 1031. The commodity information unit 1031 stores commodity information read from a commodity master 112 based on a commodity code acquired from the scanner 20. The commodity registration is performed by storing (registering) the commodity information in the commodity information unit 1031. The commodity information stored in the commodity information unit 1031 can be a commodity code, a commodity name, a price, and the like. The commodity information unit 1031 stores the commodity information related to a transaction and is cleared once a payment process for the transaction is completed.

The storage unit 110 is configured with a storage medium such as a hard disk drive (HDD) or a flash memory and keeps storage content even if power is cut off. The storage unit 110 stores a control program 111 and the commodity master 112.

The control program 111 is a program or the like for implementing a function of acquiring the commodity code from the scanner 20, a function of performing the commodity registration based on the acquired commodity code, a function of performing the payment process on the commodity subjected to the commodity registration, and the like.

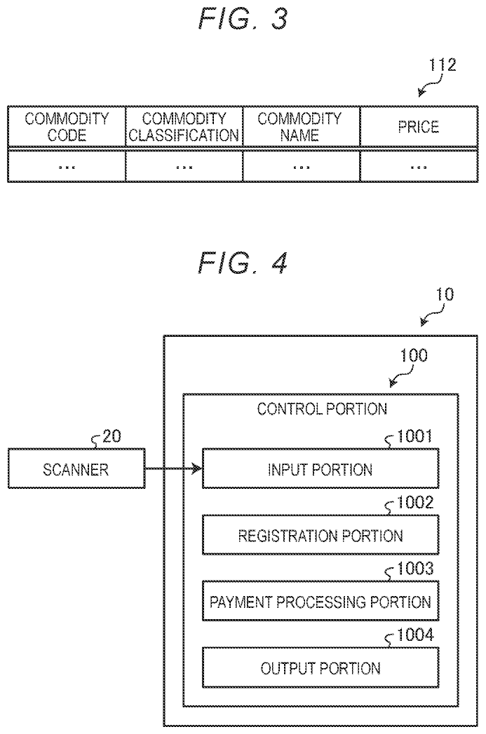

The commodity master 112 is a master file that stores commodity information regarding commodities handled in a store. Since the commodities handled in the store may be changed every day, the commodity master 112 can be appropriately updated by a store server connected via the communication unit 122. FIG. 3 is a diagram illustrating a data configuration of the commodity master 112. The commodity master 112 stores a commodity classification, a commodity name, and a price in association with the commodity code.

The commodity code is information for identifying a commodity. The commodity classification is information for classifying commodities sold in the store. The commodity name is information indicating a name of the commodity. The price is information indicating a price (unit price) of the commodity. The commodity master 112 may store other information in association with the commodity code.

Referring back to FIG. 2, a hardware configuration of the POS terminal 10 will be described. Configurations and functions of the display 51 and the touch panel 52 are as described above.

The printer 53 is configured with, for example, a thermal printer. The printer 53 prints information or the like related to a transaction on a rolled receipt sheet and dispenses the printed receipt sheet as a receipt from the dispense port 531.

The card reader 54 reads credit information necessary for settlement from a credit card inserted from the card insertion port 541. The card reader 54 reads membership information for specifying a member from a medium such as a membership card or a point card inserted from the card insertion port 541. The card reader 54 may be a card reader that reads information magnetically from a card or an integrated circuit (IC) card reader that reads information from an IC card in which an IC chip is built.

The change machine 55 receives bills and coins paid by the customer and dispenses a change as necessary if the customer pays a purchase price of commodities in cash. The bills are inserted from the bill insertion port 554 and the coins are inserted from the coin insertion port 551. Change bills are discharged from the bill discharge port 555 and change coins are discharged from the coin discharge port 552.

Configurations and functions of the first measuring unit 71, the second measuring unit 81, and the light-emitting unit 571 are as described above. The sound output unit 120 notifies the customer of information by generating a sound as necessary. For example, the sound output unit 120 outputs a report sound reporting that the commodity registration is completed. The sound output unit is an example of a report unit.

The connection interface 121 is an interface for communication with the scanner 20. The control unit 100 transmits and receives information (data) to and from the scanner 20 via the connection interface 121. The communication unit 58 is an interface for communication with an external apparatus such as a store server managed by the store. The control unit 100 transmits and receives information to and from the external apparatus via the communication unit 122.

Next, a hardware configuration of the scanner 20 will be described.

The scanner 20 specifies a commodity to be purchased by a customer using the first and second specifying methods based on a captured image obtained by imaging the commodity. The first specifying method is a method of specifying a commodity by recognizing a barcode included in a captured image, that is, a barcode attached to the imaged commodity, decoding the recognized barcode of the commodity, and reading the commodity code. The second specifying method is a method of specifying a commodity through so-called object recognition for specifying a commodity based on feature data of the external appearance of a commodity included in a commodity image, that is, feature data of the external appearance of the imaged commodity.

In the first and second specifying methods, a commodity specifying process performed by a control unit 200 may be performed by the control unit 100 of the POS terminal 10. In this case, the POS terminal 10 configures the information processing apparatus. In the first and second specifying methods, a commodity specifying process performed by the control unit 200 may be performed in cooperation of the control unit 100 of the POS terminal 10 and the control unit 200 of the scanner 20. In this case, the POS terminal 10 and the scanner 20 configure the information processing apparatus.

The scanner 20 includes the control unit 200, a storage unit 210, an imaging unit 220, and the connection interface 221. The control unit 200, the storage unit 210, the imaging unit 220, and the connection interface 221 are connected to each other via a bus 222 or the like.

The control unit 200 includes a CPU 201, a ROM 202, and a RAM 203. The CPU 201, the ROM 202, and the RAM 203 are connected to each other via the bus 222.

The CPU 201 controls the entire scanner 20. The ROM 202 stores various types of data or various programs such as a program used to drive the CPU 201. The RAM 203 is used as a work area of the CPU 201, and various programs or various types of data stored in the ROM 202 or the storage unit 210 are loaded. The control unit 200 performs various control processes of the scanner 20 when the CPU 201 operates according to a control program stored in the ROM 202 or the storage unit 210 and loaded on the RAM 203.

The storage unit 210 is configured with a storage medium such as an HDD or a flash memory and keeps storage content even if power is cut off. The storage unit 210 stores a control program 211 and a code information management table 212.

The control program 211 is a program or the like for implementing a function of acquiring a captured image of a commodity, a function of specifying the commodity of the captured image based on a commodity barcode included in the captured image, a function of specifying the commodity based on an external appearance feature of the commodity included in the captured image, a function of outputting a commodity code of the specified commodity to the POS terminal 10, and the like.

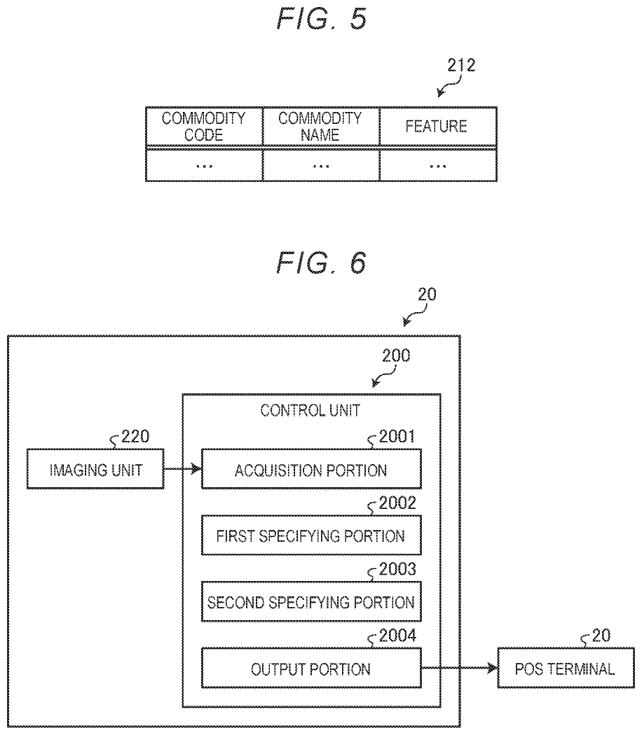

The code information management table 212 is a data table in which a commodity and feature data of the external appearance of the commodity are managed in association with each other. FIG. 5 is a diagram illustrating a data configuration of the code information management table 212. The code information management table 212 stores the commodity name and feature data in association with the commodity code.

As described above, the commodity code is information for identifying a commodity and the commodity name is information indicating a name of the commodity. The feature data is a feature in which the external appearance features of the commodity such as a standard shape of the commodity and a surface color, a pattern, and an uneven state of a surface are set as parameters. The control unit 200 specifies a commodity among commodities stored in advance in the code information management table 212 based on the feature data extracted from the external appearance of the commodity included in the captured image.

Referring back to FIG. 2, the hardware configuration of the scanner 20 will be described.

The imaging unit 220 is configured with, for example, a color CCD image sensor, a color CMOS image sensor, or the like. The imaging unit 220 images a commodity over the reading window 230 and outputs a captured image of the commodity under the control of the control unit 200. For example, the imaging unit 220 captures a moving image at a predetermined frame rate (for example, 30 fps). The imaging unit 220 stores frame images captured in sequence in the RAM 203.

The frame images (captured images of the commodity) stored in the RAM 203 are used to specify the commodity included in the frame images. In other words, the control unit 200 specifies a commodity included in the captured image, that is, a commodity imaged by the imaging unit 220, based on the captured image stored in the RAM 203.

The connection interface 221 is an interface for communication with the POS terminal 10. The control unit 200 transmits and receives information (data) to and from the POS terminal 10 via the connection interface 221.

Next, a functional configuration of the POS terminal 10 will be described. FIG. 4 is a block diagram illustrating a functional configuration of the control unit 100 of the POS terminal 10. The control unit 100 functions as an input portion 1001, a registration portion 1002, a payment processing portion 1003, and an output portion 1004 when the CPU 101 operates according to the control program stored in the ROM 102 or the storage unit 110. These functions may be configured with hardware such as dedicated circuits.

Various types of information are input to the input portion 1001 from the scanner 20, the touch panel 52, the card reader 54, the first measuring unit 71, the second measuring unit 81, and the like. For example, the commodity codes are input to the input portion 1001 from the scanner 20.

Information based on an operation of the touch panel 52 is input to the input portion 1001. For example, transaction start information for declaring start of one transaction is input to the input portion 1001. Registration completion information indicating that the commodity registration of commodities in one transaction is completed is input to the input portion 1001.

The registration portion 1002 performs the commodity registration of the commodities to be purchased by a customer through an operation of the customer. In other words, the registration portion 1002 registers information regarding a commodity identified with the commodity identification information input to the input portion 1001. Specifically, the registration portion 1002 reads the commodity information from the commodity master 112 based on the commodity code input to the input portion 1001. Then, the registration portion 1002 stores the read commodity information in the commodity information unit 1031. The commodity information is information including the commodity code, the commodity name, and the price.

The payment processing portion 1003 performs a payment process on payment of a price of the commodity subjected to the commodity registration by the registration portion 1002. Specifically, the payment processing portion 1003 performs processes of calculating a total price (transaction amount) of the commodities subjected to the commodity registration, calculating a change amount, displaying various types of The payment processing information, and dispensing a receipt. portion 1003 can perform a payment process necessary for settlement if the customer desires cashless settlement such as credit settlement or two-dimensional code settlement.

The output portion 1004 outputs various types of information to the scanner 20, the printer 53, the change machine 55, the light-emitting unit 571, the sound output unit 120, and the like. For example, when the transaction start information is input to the input portion 1001, the output portion 1004 outputs an imaging start signal for instructing a start of imaging to the scanner 20. When the registration completion information is input to the input portion 1001, the output portion 1004 outputs an imaging stop signal for instructing a stop of imaging to the scanner 20.

When the registration portion 1002 completes the commodity registration related to a commodity, the output portion 1004 outputs a control signal for outputting the report sound to the sound output unit 120. The output portion 1004 causes the report unit (the sound output unit 120) to report that registration of the commodity has been completed by the registration portion 1002. The sound output unit 120 can also or instead be provided in the scanner 20. In such a case, the sound output unit 120 may emit the report sound when the scanner 20 specifies (identifies) the commodity code.

Next, a functional configuration of the scanner 20 will be described. FIG. 6 is a block diagram illustrating a functional configuration of the control unit 200 of the scanner 20. The control unit 200 functions as an acquisition portion 2001, a first specifying portion 2002, a second specifying portion 2003, and an output portion 2004 when the CPU 201 operates according to the control program stored in the ROM 202 or the storage unit 210. These functions may be implemented as hardware such as dedicated circuits.

The acquisition portion 2001 acquires a captured image of the commodity. Specifically, the acquisition portion 2001 acquires a frame image (a “captured image”) obtained by causing the imaging unit 220 to image the commodity and stores the captured image in the RAM 203. The acquisition portion 2001 may acquire all the captured images of the commodities or may acquire only the necessary captured images captured by the imaging unit 220 in sequence. In some examples, the acquisition portion 2001 may acquire captured images of the commodities from an external camera.

The acquisition portion 2001 acquires other various types of information. For example, the acquisition portion 2001 acquires the imaging start signal and the imaging stop signal from the POS terminal 10.

The first specifying portion 2002 identifies (specifies) a commodity depicted in the captured image using the first specifying method. Specifically, the first specifying portion 2002 specifies the commodity based on the code symbol on the commodity included in the captured image. More specifically, the first specifying portion 2002 extracts a commodity barcode from the captured image. The first specifying portion 2002 decodes (reads) the commodity code from the extracted commodity barcode.

Since the commodity code is commodity identification information, the reading of the commodity code, that is, the identification of the commodity code, is synonymous with specifying the commodity. Accordingly, the first specifying portion 2002 can specify the commodity by reading the commodity code from the commodity barcode depicted in the captured image.

The second specifying portion 2003 specifies the commodity depicted in the captured image using the second specifying method. Specifically, the second specifying portion 2003 identifies (specifies) the commodity based on the external appearance features of the commodity depicted in the captured image acquired by the acquisition portion 2001. More specifically, the second specifying portion p 2003 extracts feature data corresponding to the external appearance of the commodity from the captured image. The second specifying portion 2003 specifies the commodity code corresponding to the extracted feature data by referring to the code information management table 212. The second specifying portion 2003 specifies the commodity by identifying the commodity code for the commodity associated with the feature data.

The second specifying portion 2003 may specify the commodity code using character recognition (optical character recognition). In this case, the code information management table 212 stores the commodity code and character information in association with each other. In some examples, the second specifying portion 2003 identifies the commodity code by extracting an external appearance image of the commodity from the captured image, recognizing characters or text included in the external appearance image, and then referring to the code information management table 212.

The output portion 2004 outputs the commodity identification information as specified by the first specifying portion 2002 or the second specifying portion 2003. Specifically, the output portion 2004 outputs the commodity code specified by the first specifying portion 2002 or the second specifying portion 2003 to the POS terminal 10 via the connection interface 221.

More specifically, the output portion 2004 outputs the commodity code as specified by the first specifying portion 2002 if the specifying of the commodity by the first specifying portion 2002 is completed before the specifying of the commodity by the second specifying portion 2003 or within a predetermined amount of time after the specifying of the commodity by the second specifying portion 2003. The output portion 2004 outputs the commodity code as specified by the second specifying portion 2003 if the specifying of the commodity by the first specifying portion 2002 occurs after the elapse of the predetermined amount of time from the specifying of the commodity by the second specifying portion 2003.

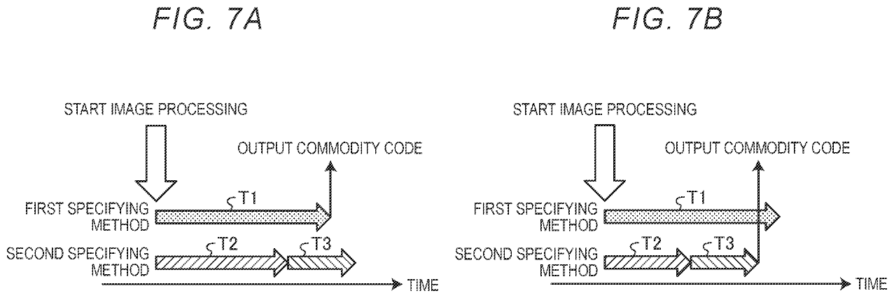

Here, the timing at which the scanner 20 outputs the commodity code to the POS terminal 10 will be described. FIGS. 7A and 7B are diagrams illustrating an output timing for the commodity code by the control unit 200 of the scanner 20. FIG. 7A illustrates a case where the commodity code is specified by the first specifying portion 2002 using the first specifying method, then output. FIG. 7B illustrates a case where the commodity code is specified by the second specifying portion 2003 using the second specifying method then output.

The first specifying portion 2002 performs the first specifying method (also referred to as a “first specifying process”) at the same time as the second specifying portion 2003 performs the second specifying method (also referred to as a “second specifying process”). In FIGS. 7A and 7B, time T1 is the time at which the first specifying portion 2002 successfully specifies the commodity code, time T2 is the time at which the second specifying portion 2003 successfully specifies the commodity code, and waiting time T3 is a preset waiting time.

Time T1 is a time at which the first specifying portion 2002 specifies the commodity code. Such a time T1 may also include a case where a plurality of captured images are processed to identify the commodity code using the first specifying method. Similarly, time T2 is a time at which the second specifying portion 2003 specifies the commodity code. Such a time T2 may also include a case where a plurality of captured images are processed to identify the commodity code using the second specifying method.

The waiting time T3 is an example of a predetermined time from the specifying of the commodity by the second specifying portion 2003. In general, accuracy of the specifying of the commodity code based on the commodity barcode will be higher than accuracy of the specifying of the commodity code based on the feature data corresponding to the external appearance of the commodity. Therefore, in the present embodiment, the waiting time T3 is set to prioritize the specifying by the first specifying portion 2002 as much as possible. The waiting time T3 is set to a length of a time for which an operator will not typically feel the operability of the scanner 2 to be bad (poor) even if the commodity code can not be achieved by the first specifying portion 2002 but, in general, can be set to any time by store into which the self-service POS system 1 is introduced.

By setting the waiting time T3, it is possible to provide accuracy in the specifying of the commodities while still improving the operator's use experience. In some examples, the waiting time T3 need not be necessarily set or may be set to zero.

In FIG. 7A, since time T1<time T2+waiting time T3, the specifying result of the commodity code by the first specifying portion 2002 is output to the POS terminal 10. In this example, the specifying of the commodity code by the second specifying portion 2003 is actually completed earlier than the specifying of the commodity code by the first specifying portion 2002, but the output portion 2004 prioritizes identification accuracy of the commodity code and thus outputs the commodity code as specified by the first specifying portion 2002 since the waiting time T3 was not finished.

In FIG. 7B, since time T1>time T2+waiting time T3, the specifying result of the commodity code by the second specifying portion 2003 is output to the POS terminal 10. In this example, the identification of the commodity code by the second specifying portion 2003 is completed earlier than the identification of the commodity code by the first specifying portion 2002 (as was also the case in the example illustrated in FIG. 7A). However, since operator usability is considered to deteriorate if it is required to wait too long for the identification by the commodity code, the output portion 2004 prioritizes operability and outputs the commodity code as specified by the second specifying portion 2003 rather than waiting for the potentially more accurate identification by the first specifying portion 2002.

When time T1=time T2+waiting time T3, the output portion 2004 desirably outputs the commodity code as specified by the first specifying portion 2002 since identification usually has higher accuracy.

Next, an operation of the scanner 20 will be described. The scanner 20 operates the imaging unit 220 and performs the first and second specifying processes in parallel after the imaging start signal is acquired from the POS terminal 10.

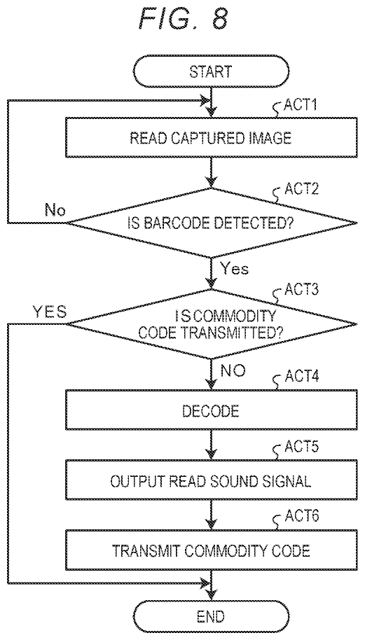

First, the first specifying process will be described. FIG. 8 is a flowchart illustrating a flow of an operation of the first specifying process by the control unit 200 of the scanner 20.

The first specifying portion 2002 reads a captured image from the RAM 203 (ACT 1). Subsequently, the control unit 200 determines whether the first specifying portion 2002 detects the commodity barcode from the read captured image (ACT 2). In other words, the control unit 200 determines whether the commodity barcode is captured in the read frame image.

If the commodity barcode is not detected in the captured image (N in ACT 2), the control unit 200 returns to the process of ACT 1. In this case, the first specifying portion 2002 reads a subsequent captured image from the RAM 203. If the commodity barcode is detected in the captured image (Y in ACT 2), the control unit 200 next determines whether the output portion 2004 has already transmitted the commodity code to the POS terminal 10 (ACT 3). In other words, the control unit 200 determines whether the output portion 2004 has already sent the commodity code specified by the second specifying portion 2003 to the POS terminal 10.

If the commodity code has been transmitted (Y in ACT 3), the control unit 200 ends the first specifying process. If the commodity code has not yet been transmitted (N in ACT 3), the first specifying portion 2002 proceeds to decode the commodity barcode detected in the captured image and thus reads the commodity code as indicated by the detected commodity barcode (ACT 4).

The output portion 2004 then outputs a signal for causing the sound output unit 120 to output the report sound (ACT 5). Next, the output portion 2004 outputs the read commodity code to the POS terminal 10 (ACT 6). Then, the control unit 200 ends the first specifying process.

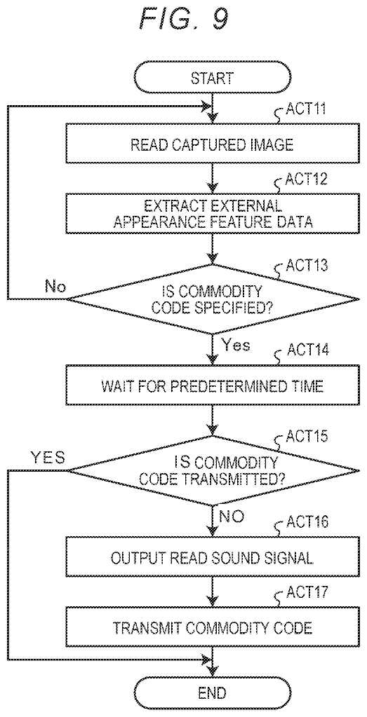

Next, the second specifying process will be described. FIG. 9 is a flowchart illustrating a flow of an operation of the second specifying process by the control unit 200 of the scanner 20.

The second specifying portion 2003 reads the captured image from the RAM 203 (ACT 11). Next, the second specifying portion 2003 extracts the feature data corresponding to the external appearance of the commodity from the read captured image (ACT 12). Based on the feature data extracted by the second specifying portion 2003, the control unit 200 determines whether a commodity code can be specified (ACT 13).

If the second specifying portion 2003 does not identify the commodity code (N in ACT 13), the control unit 200 returns to the process of ACT 11. In this case, the second specifying portion 2003 reads a subsequent captured image from the RAM 203. If the second specifying portion 2003 identifies the commodity code (Y in ACT 13), the control unit 200 waits for a predetermined time (time T3 in FIGS. 7A and 7B) (ACT 14).

Next, the control unit 200 determines whether the output portion 2004 has already transmitted the commodity code to the POS terminal 10 (ACT 15). In other words, the control unit 200 determines whether the output portion 2004 has already sent the commodity code as specified by the first specifying portion 2002 to the POS terminal 10.

If the commodity code has already been transmitted (Y in ACT 15), that is, if the output portion 2004 already sent the commodity code as specified by the first specifying portion 2002, the control unit 200 ends the second specifying process.

If the commodity code is not yet transmitted (N in ACT 15), the output portion 2004 outputs a signal for causing the sound output unit 120 to output the report sound (ACT 16). Next, the output portion 2004 outputs the read commodity code to the POS terminal 10 (ACT 17). Then, the control unit 200 ends the second specifying process.

The control unit 200 of the scanner 20 performs the first and second specifying processes in parallel and outputs an identified commodity code to the POS terminal 10 whether decoded from a barcode or obtained by object recognition. Accordingly, if a relatively time is required to determine the commodity code by the first specifying process, the scanner 20 may be able to more quickly identify the commodity code through the second specifying process. Conversely, if a relatively long time is required to identify the commodity code through the second specifying process, the scanner 20 can be able to more quickly identify the commodity code through the first specifying process.

As described above, the scanner 20 of an embodiment includes an acquisition portion 2001 that acquires a captured image of a commodity; a first specifying portion 2002 that specifies a commodity based on the commodity barcode included in the captured image; a second specifying portion 2003 that specifies a commodity based on the external appearance features of the commodity as depicted in the captured image; and an output portion 2004 that outputs the commodity code as specified by the first specifying portion 2002 or the second specifying portion 2003.

Accordingly, the scanner 20 can identify the commodity included in the captured image based on external appearance or by a commodity barcode. As a result, it is possible to speed the reading of the commodity codes by an operator. Therefore, the scanner 20 can improve the operability of the scanner 20 for identifying commodities.

In the scanner 20, the output portion 2004 outputs the commodity code as specified by the first specifying portion 2002 if the specifying by the first specifying portion 2002 is completed before the elapse of some predetermined time the after identification of the commodity by the second specifying portion 2003.

Accordingly, the scanner 20 can output the commodity code as specified by the first specifying portion 2002 since it may be considered that such identification is usually performed with higher accuracy than by the identification method of the second specifying portion 2003.

The output portion 2004 of the scanner 20 outputs the commodity code for identifying the commodity as specified by the second specifying portion 2003 if the identification of the commodity by the first specifying portion 2002 is completed later than after the elapse of the predetermined time from the specifying of the commodity by the second specifying portion 2003.

Accordingly, the scanner 20 can in some cases output a commodity code sooner by outputting the commodity code as specified by the second specifying portion 2003 rather than waiting for the commodity code to be identified by the first specifying portion 2002. As a result, it is possible to reduce the reading time of the commodity codes for an operator. Therefore, the scanner 20 can improve the operator's operability for specifying the commodity while guaranteeing reading accuracy.

The POS terminal 10 in the self-service POS system 1 of an embodiment includes the output portion 1004 (report portion) that reports that a commodity registration has been completed by the registration portion 1002 to the report unit.

Accordingly, the operator can recognize the completion of the commodity registration even if the commodity registration is completed without the commodity barcode being held up to the reading window 230. Therefore, the self-service POS system 1 can improve the operator's throughput.

In an embodiment, control programs executed by the POS terminal 10 and the scanner 20 may be recorded on a non-transitory, computer-readable recording medium such as a CD-ROM. The control programs executed by the POS terminal 10 and the scanner 20 of an embodiment may be stored on a computer connected to a network, such as the Internet, and downloaded, accessed, or otherwise provided via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A point-of-sale apparatus, comprising:
a connection interface connectable to a point-of-sale (POS) terminal; and
a control unit connectable to an imaging unit and configured to:
acquire a captured image of a commodity from the imaging unit;
attempt to identify the commodity in the image using a code symbol attached to the commodity;
attempt to identify the commodity based on external appearance feature data of the commodity in in the captured image; and
output commodity identification information for the commodity to the POS terminal according to either the code symbol or the external feature data.

2. The point-of-sale apparatus according to claim 1, wherein the control unit is configured to output commodity identification information according to the code symbol if the attempt to identify the commodity using the code symbol is successfully completed before the successful completion of the attempt to identify the commodity based on external appearance feature data.

3. The point-of-sale apparatus according to claim 2, wherein the control unit is configured to output commodity identification information according to the code symbol if the attempt to identify the commodity using the code symbol is successfully completed within a predetermined time after the successful completion of the attempt to identify the commodity based on external appearance feature data.

4. The point-of-sale apparatus according to claim 3, wherein the control unit is configured to output commodity identification information according to the external appearance feature data if the attempt to identify the commodity using the code symbol is not successfully completed before the predetermined time elapses after the successful completion of the attempt to identify the commodity based on external appearance feature data.

5. The point-of-sale apparatus according to claim 1, wherein the control unit is configured to output commodity identification information according to the code symbol if the attempt to identify the commodity using the code symbol is successfully completed within a predetermined time after the successful completion of the attempt to identify the commodity based on external appearance feature data.

6. The point-of-sale apparatus according to claim 5, wherein the control unit is configured to output commodity identification information according to the external appearance feature data if the attempt to identify the commodity using the code symbol is not successfully completed before the predetermined time elapses after the successful completion of the attempt to identify the commodity based on external appearance feature data.

7. The point-of-sale apparatus according to claim 1, wherein the control unit is connected to the imaging unit by a bus.

8. The point-of-sale apparatus according to claim 1, wherein the connection interface is connected to the POS terminal.

9. A point-of-sale apparatus, comprising:
a camera configured to capture an image of a commodity held in front of the camera; and
a processor configured to:
receive the captured image of the commodity from the camera;
attempt to identify a barcode in the captured image and decode the barcode to identify the commodity;
attempt to perform object recognition using the captured image to identify the commodity;
output an identification of the commodity based on the decoding of the barcode if obtained either before completion of the object recognition or within a preset limit of time after completion of the objection recognition, and output an identification of the commodity based on completion of the object recognition otherwise.

10. The point-of-sale apparatus according to claim 9, further comprising:
a bus; and
a camera interface connected to the bus, wherein
the camera is connected to camera interface, and
the processor is connected to the bus.

11. The point-of-sale apparatus according to claim 9, further comprising:
a connection interface connectable to a point-of-sale (POS) terminal, wherein
the processor is configured to output the identification of the commodity based on the decoding of the barcode and the identification of the commodity based on the object recognition to POS terminal via the connection interface.

12. A commodity information registration system, comprising:
a point-of-sale apparatus configured to identify a commodity in a captured image of the commodity; and
a point-of-sale terminal configured to register information of the commodity identified by the point-of-sale apparatus, wherein
the point-of-sale apparatus includes:
a connection interface connected to the point-of-sale terminal; and
a control unit connectable to an imaging unit and configured to:
acquire a captured image of a commodity from the imaging unit;
attempt to identify the commodity in the image using a code symbol attached to the commodity;
attempt to identify the commodity based on external appearance feature data of the commodity in in the captured image; and
output commodity identification information for the commodity to the point-of-sale terminal according to either the code symbol or the external feature data.

13. The commodity information registration system according to claim 12, further comprising:
a sound output unit configured to output a sound reporting that the registration of the commodity has been completed.

14. The commodity information registration system according to claim 12, wherein the control unit is configured to output commodity identification information according to the code symbol if the attempt to identify the commodity using the code symbol is successfully completed before the successful completion of the attempt to identify the commodity based on external appearance feature data.

15. The commodity information registration system according to claim 14, wherein the control unit is configured to output commodity identification information according to the code symbol if the attempt to identify the commodity using the code symbol is successfully completed within a predetermined time after the successful completion of the attempt to identify the commodity based on external appearance feature data.

16. The commodity information registration system according to claim 15, wherein the control unit is configured to output commodity identification information according to the external appearance feature data if the attempt to identify the commodity using the code symbol is not successfully completed before the predetermined time elapses after the successful completion of the attempt to identify the commodity based on external appearance feature data.

17. The commodity information registration system according to claim 12, wherein the control unit is configured to output commodity identification information according to the code symbol if the attempt to identify the commodity using the code symbol is successfully completed within a predetermined time after the successful completion of the attempt to identify the commodity based on external appearance feature data.

18. The commodity information registration system according to claim 17, wherein the control unit is configured to output commodity identification information according to the external appearance feature data if the attempt to identify the commodity using the code symbol is not successfully completed before the predetermined time elapses after the successful completion of the attempt to identify the commodity based on external appearance feature data.

19. The commodity information registration system according to claim 12, wherein the control unit is connected to the imaging unit by a bus.

20. The commodity information registration system according to claim 12, wherein the attempt to identify the commodity in the image using a code symbol attached to the commodity and the attempt to identify the commodity based on external appearance feature data of the commodity in in the captured image occur simultaneously.
